(19) United States
(12) Patent Application Publication
(10) Pub. No.: US 2025/0138877 A1
(43) Pub. Date: May 1, 2025

(54) DYNAMIC CORE CLASS AFFINITIZATION IN AN INFORMATION HANDLING SYSTEM

(71) Applicant: DELL PRODUCTS L.P., Round Rock, TX (US)

(72) Inventors: Farzad Khosrowpour, Pflugerville, TX (US); Mitchell Markow, Hutto, TX (US); Suraj M. Varma, Portland, OR (US)

(21) Appl. No.: 18/499,263

(22) Filed: Nov. 1, 2023

(51) Int. Cl. G06F 9/48; G06F 9/50

(52) U.S. Cl. CPC G06F 9/4881; G06F 9/5033; G06F 2209/5018

(57) ABSTRACT

An information handling system includes a processor and a scheduler. The processor includes first cores of a first type and second cores of a second type and provides affinity information associated with first cores and the second cores. The scheduler schedules threads on the first cores and the second cores based on the affinity information. The information handling system provides an indication to the scheduler to schedule a thread on the first cores. The scheduler determines that thread is to be scheduled on the second cores based on the affinity information, and schedules the thread on the first cores based on the indication.

### FIELD OF THE DISCLOSURE

This disclosure generally relates to information handling systems, and more particularly relates to dynamic core class affinitization in an information handling systems.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a processor having first cores of one type and second cores of a different type and may provide affinity information associated with first cores and the second cores. A scheduler may schedule threads on the first cores and the second cores based on the affinity information. The information handling system may provide an indication to the scheduler to schedule a thread on the first cores. The scheduler may determine that thread is to be scheduled on the second cores based on the affinity information, and may schedule the thread on the first cores based on the indication.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system according to an embodiment of the current disclosure; and

FIG. 2 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

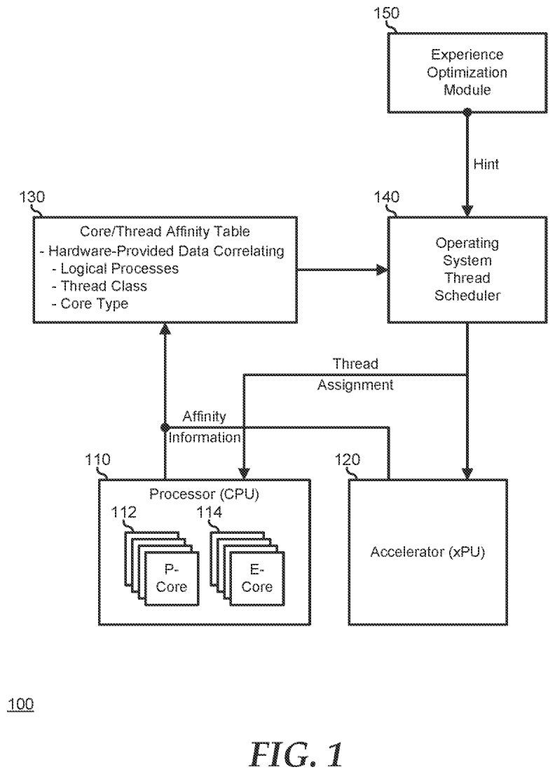

FIG. 1 illustrates an information handling system 100 including a processor (CPU) 110 and an accelerator (xPU) 120. CPU 110 and xPU 120 represent processing hardware implemented on information handling system 100. Information handling system 100 may include other hardware elements, such as one or more input/output (I/O) hub, system main memory devices such as one or more dual inline memory module (DIMM), storage devices, network interface devices, human interface devices (HIDs), or the like. In this regard, CPU 110 represents one or more multi-core general purpose processing devices, and is characterized by the fact that the CPU includes multiple cores suitable for high-performance processing (P-cores) 112, and multiple cores suitable for low-power/efficient processing (E-cores) 114. xPU 120 represents one or more processing device that is optimized to a particular processing task, such as a graphics processing unit (GPU), a field programmable gate array (FPGA) device, a cryptographic accelerator, an artificial intelligence/machine learning accelerator, an application specific integrated circuit (ASIC), a system-on-a-chip (SoC) device, or another type of accelerator device, as needed or desired.

The hardware elements of information handling system 100, including CPU 110 and xPU 120, operate to instantiate a host operating environment. In particular, information handling system 100 may include a basic input/output system (BIOS)/universal extensible firmware interface (UEFI) that initializes the information handling system, and launches an operating system (OS) to perform the processing tasks as directed by a user of the information handling system, as needed or desired. The host operating environment includes a core/thread affinity table 130, an OS thread scheduler 140, and an experience optimization module 150, as described further below.

Information handling system 100 operates in various operating modes based upon such considerations as user preference or desires for performance operations versus efficiency operations or the like. For example, a user may desire to operate information handling system 100 as efficiently as possible in order to prolong battery-based operations, or may desire to operate the information handling system with a high level of processing performance for gaming applications, or the like. To this end, information handling system 100 provides hardware assisted scheduling of threads to be executed on P-cores 112, E-cores 114, and xPU 120, based upon information provided by CPU 110 and the xPU. In particular, CPU 110 and xPU 120 operate to populate core/thread affinity table 130 with information that correlates the various logical processes being executed on the CPU and the xPU with various classifications for the threads to be launched on the CPU and the xPU, and with the various core types available on the CPU and the xPU (that is P-cores 112, E-cores 114, and the xPU processor).

Various manufacturers of processors, such as CPU 110 and xPU 120, may provide hardware assisted scheduling information for use by OS thread scheduler 140. However, such information may be proprietary to the particular manufacturer. For example, an information handling system may utilize processors fabricated by Intel which provides a Hardware Guided Scheduling (HGS) that provides fixed affinities for various types of operating modes. For example, when such an information handling system is in a battery operating mode, an OS thread scheduler may execute threads preferentially on E-cores until all such E-cores are utilized, before scheduling further threads to be executed on the available P-cores. In other cases, an information handling system may utilize processors fabricated by Intel which provides an enhanced HGS scheme (HGS+) that provides greater flexibility in categorizing thread classes, and giving E-core to P-core ratio information that correlates with the thread classes, thereby permitting an OS thread scheduler greater flexibility in scheduling the threads to be executed on the E-cores and the P-cores. The details of thread scheduling utilizing, for example Intel HGS or Intel HGS+ are known in the art and will not be further described herein, except as may be needed to illustrate the current embodiments.

It has been understood by the inventors of the current disclosure that the control of scheduling of threads on processors in an information handling system are typically under the exclusive control of the processor manufacturers and the associated OS providers. That is, the users of such information handling systems, and particularly the manufacturers of the information handling systems, have little to no control or insight into the operations of the hardware assisted task scheduling on their own information handling systems. In particular, typical hardware assisted task scheduling provides for efficiency operations or for performance operations, but gives scant ability to provide hybrid operating modes where some threads are scheduled onto E-cores while other threads are scheduled onto P-cores. Rather, in general, the scheduling algorithms supported by the processor manufacturers and the associated OS providers may schedule threads on E-cores in the performance mode of operation when no more P-cores are available, and may schedule threads on P-cores in the efficiency mode of operation when no more E-cores are available. However, it may be desirable, for example, for a user to select the efficiency mode of operation for the purposes of scheduling most threads, but for the user to nevertheless desire to run a particular application or program at a higher performance level, and to thus desire the threads associated with the particular application or program to be scheduled onto the available P-cores. For example, a user may desire to have background task scheduled as efficiently as possible on the available E-cores, while yet running a game application, office productivity software, or the like in the performance mode on the available P-cores.

Experience optimization module 150 operates to provide an interface whereby the user of information handling system 100 selects a desired operating mode (i.e., efficiency mode, battery mode, performance mode, or the like), and to also select various particular applications or programs to be operated in a different mode. Experience optimization module 150 then provides a hint to OS thread scheduler 140 to schedule threads associated with the selected applications or programs on available P-cores 112. For example, when information handling system 100 is operating in the efficiency or battery mode, OS thread scheduler 140 may be expected to schedule threads associated with the selected applications or programs on available E-cores 114 based on the hardware assisted task scheduling mechanism as described above. However, with the hint provided by experience optimization module 150, OS thread scheduler 140 operates to override the normal hardware assisted task scheduling operation and schedule threads associated with the selected application or program on available P-cores 112.

In another example, when information handling system 100 is operating in the performance mode, OS thread scheduler 140 may be expected to schedule threads associated with the selected applications or programs on available P-cores 112 based on the hardware assisted task scheduling mechanism as described above. However, with the hint provided by experience optimization module 150, OS thread scheduler 140 operates to override the normal hardware assisted task scheduling operation and schedule threads associated with the selected application or program on available E-cores 114. This case may be desirable in order to schedule various background tasks or other low-priority tasks on E-cores 114 to achieve some level of power savings while operating information handling system 100 in the performance mode. However the hint from experience optimization module 150 may be understood to be a soft hint, in that OS thread scheduler 140 may yet opt to ignore the hint and schedule threads associated with the selected application or program in accordance with the normal operation of the hardware assisted task scheduling. For example, it may be known that a particular program or application requires the functionality of P-cores 112 in order to execute correctly. OS thread scheduler 140 may opt to ignore a hint to execute such a program or application on E-cores 114 and may schedule threads associated with the selected program or application on P-cores 112 in spite of the information included in the hint from experience optimization module 150.

In a particular embodiment, the hardware assisted task scheduling in general, and the use and scheduling performed by OS thread scheduler 140 in particular, are extended to cover the utilization and scheduling of xPU 120. In particular, xPU 120 operates to provide affinity information to core/thread affinity table 130, similar to the affinity information provided by CPU 110. Additionally, xPU 120 provides information as to the type of acceleration that is performed by the xPU. For example, xPU 120 may represent a graphics processing unit (GPU), an encryption engine, or another type of accelerator, as needed or desired, and the xPU provides information that indicates the type of processing and efficiency information related to the particular type of processing. Then OS thread scheduler 140 operates to assign threads not only between P-cores 112 and E-cores 114, but also with xPU 120.

In this regard, experience optimization module 150 operates to provide hints to OS thread scheduler 140 related to the use and scheduling of xPU 120 that may be in conflict with the scheduling otherwise performed under the hardware assisted scheduling. For example, in an efficiency or battery mode, a particular task or thread may be normally scheduled to E-cores 114. However, experience optimization module 150 may provide a hint indicating that the desired performance necessitates that particular task or thread to be scheduled onto xPU 120, and OS thread scheduler 140 then operates to schedule that task or thread on the xPU. In another example, when information handling system 100 is in the performance mode, a particular task or thread may be normally scheduled to xPU 120. However, experience optimization module 150 may provide a hint indicating that the desired efficiency necessitates that particular task or thread to be scheduled onto P-cores 112 or E-cores 114, and OS thread scheduler 140 then operates to schedule that task or thread on the P-cores or E-cores.

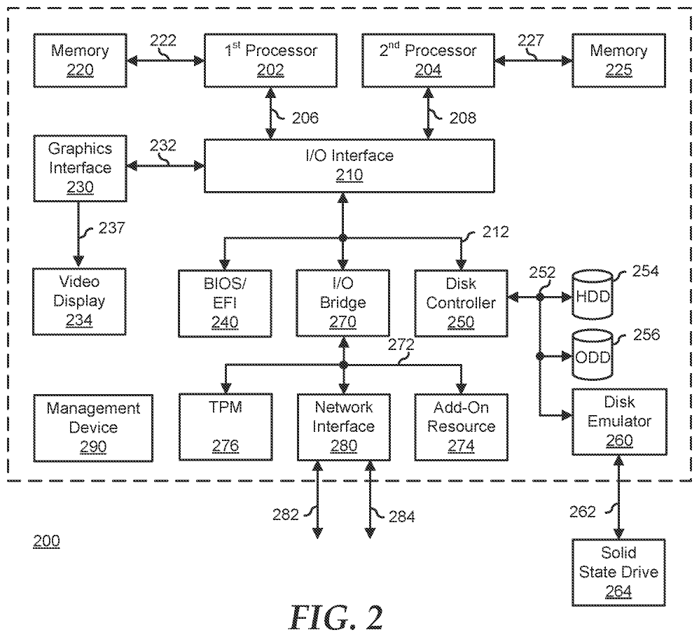

FIG. 2 illustrates a generalized embodiment of an information handling system 200. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 200 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 200 can include processing resources for executing machine-executable code, such as a central processing unit (CPU), a programmable logic array (PLA), an embedded device such as a System-on-a-Chip (SoC), or other control logic hardware. Information handling system 200 can also include one or more computer-readable medium for storing machine-executable code, such as software or data. Additional components of information handling system 200 can include one or more storage devices that can store machine-executable code, one or more communications ports for communicating with external devices, and various input and output (I/O) devices, such as a keyboard, a mouse, and a video display. Information handling system 200 can also include one or more buses operable to transmit information between the various hardware components.

Information handling system 200 can include devices or modules that embody one or more of the devices or modules described below, and operates to perform one or more of the methods described below. Information handling system 200 includes a processors 202 and 204, an input/output (I/O) interface 210, memories 220 and 225, a graphics interface 230, a basic input and output system/universal extensible firmware interface (BIOS/UEFI) module 240, a disk controller 250, a hard disk drive (HDD) 254, an optical disk drive (ODD) 256, a disk emulator 260 connected to an external solid state drive (SSD) 264, an I/O bridge 270, one or more add-on resources 274, a trusted platform module (TPM) 276, a network interface 280, a management device 290, and a power supply 295. Processors 202 and 204, I/O interface 210, memory 220, graphics interface 230, BIOS/UEFI module 240, disk controller 250, HDD 254, ODD 256, disk emulator 260, SSD 264, I/O bridge 270, add-on resources 274, TPM 276, and network interface 280 operate together to provide a host environment of information handling system 200 that operates to provide the data processing functionality of the information handling system. The host environment operates to execute machine-executable code, including platform BIOS/UEFI code, device firmware, operating system code, applications, programs, and the like, to perform the data processing tasks associated with information handling system 200.

In the host environment, processor 202 is connected to I/O interface 210 via processor interface 206, and processor 204 is connected to the I/O interface via processor interface 208. Memory 220 is connected to processor 202 via a memory interface 222. Memory 225 is connected to processor 204 via a memory interface 227. Graphics interface 230 is connected to I/O interface 210 via a graphics interface 232, and provides a video display output 236 to a video display 234. In a particular embodiment, information handling system 200 includes separate memories that are dedicated to each of processors 202 and 204 via separate memory interfaces. An example of memories 220 and 225 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 240, disk controller 250, and I/O bridge 270 are connected to I/O interface 210 via an I/O channel 212. An example of I/O channel 212 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 210 can also include one or more other I/O interfaces, including an Industry Standard Architecture (ISA) interface, a Small Computer Serial Interface (SCSI) interface, an Inter-Integrated Circuit (I′C) interface, a System Pheripheral Interface (SPI), a Universal Serial Bus (USB), another interface, or a combination thereof. BIOS/UEFI module 240 includes BIOS/UEFI code operable to detect resources within information handling system 200, to provide drivers for the resources, initialize the resources, and access the resources. BIOS/UEFI module 240 includes code that operates to detect resources within information handling system 200, to provide drivers for the resources, to initialize the resources, and to access the resources.

Disk controller 250 includes a disk interface 252 that connects the disk controller to HDD 254, to ODD 256, and to disk emulator 260. An example of disk interface 252 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 260 permits SSD 264 to be connected to information handling system 200 via an external interface 262. An example of external interface 262 includes a USB interface, an IEEE 2394 (Firewire) interface, a proprietary interface, or a combination thereof. Alternatively, solid-state drive 264 can be disposed within information handling system 200.

I/O bridge 270 includes a peripheral interface 272 that connects the I/O bridge to add-on resource 274, to TPM 276, and to network interface 280. Peripheral interface 272 can be the same type of interface as I/O channel 212, or can be a different type of interface. As such, I/O bridge 270 extends the capacity of I/O channel 212 when peripheral interface 272 and the I/O channel are of the same type, and the I/O bridge translates information from a format suitable to the I/O channel to a format suitable to the peripheral channel 272 when they are of a different type. Add-on resource 274 can include a data storage system, an additional graphics interface, a network interface card (NIC), a sound/video processing card, another add-on resource, or a combination thereof. Add-on resource 274 can be on a main circuit board, on separate circuit board or add-in card disposed within information handling system 200, a device that is external to the information handling system, or a combination thereof.

Network interface 280 represents a NIC disposed within information handling system 200, on a main circuit board of the information handling system, integrated onto another component such as I/O interface 210, in another suitable location, or a combination thereof. Network interface device 280 includes network channels 282 and 284 that provide interfaces to devices that are external to information handling system 200. In a particular embodiment, network channels 282 and 284 are of a different type than peripheral channel 272 and network interface 280 translates information from a format suitable to the peripheral channel to a format suitable to external devices. An example of network channels 282 and 284 includes InfiniBand channels, Fibre Channel channels, Gigabit Ethernet channels, proprietary channel architectures, or a combination thereof. Network channels 282 and 284 can be connected to external network resources (not illustrated). The network resource can include another information handling system, a data storage system, another network, a grid management system, another suitable resource, or a combination thereof.

Management device 290 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 200. In particular, management device 290 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 200, such as system cooling fans and power supplies. Management device 290 can include a network connection to an external management system, and the management device can communicate with the management system to report status information for information handling system 200, to receive BIOS/UEFI or system firmware updates, or to perform other task for managing and controlling the operation of information handling system 200. Management device 290 can operate off of a separate power plane from the components of the host environment so that the management device receives power to manage information handling system 200 when the information handling system is otherwise shut down. An example of management device 290 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 290 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a processor having first cores of a first type and second cores of a second type, the processor configured to provide first affinity information associated with the first cores and the second cores; and
a scheduler configured to schedule threads on the first cores and the second cores based on the first affinity information;
wherein the information handling system is configured to provide a first indication to the scheduler to schedule a first thread on the first cores; and
wherein the scheduler is further configured to determine that the first thread is to be scheduled on the second cores based on the first affinity information, and to schedule the first thread on the first cores based on the first indication.

2. The information handling system of claim 1, wherein the first cores include performance cores and the second cores include efficiency cores.

3. The information handling system of claim 2, wherein the scheduler determines that the first thread is to be scheduled on the second cores when the information handling system is in an efficiency mode of operation.

4. The information handling system of claim 3, wherein the information handling system provides the first indication in response to a user input to the information handling system, the user input selecting the first thread.

5. The information handling system of claim 2, wherein:
the information handling system is further configured to provide a second indication to the scheduler to schedule a second thread on the second cores; and
the scheduler is further configured to determine that second thread is to be scheduled on the first cores based on the first affinity information, and to schedule the second thread on the second cores based on the second indication.

6. The information handling system of claim 5, wherein the scheduler determines that the second thread is to be scheduled on the first cores when the information handling system is in a performance mode of operation.

7. The information handling system of claim 6, wherein the information handling system provides the second indication in response to a user input to the information handling system, the user input selecting the second thread.

8. The information handling system of claim 1, further comprising a memory device, wherein the processor is further configured to store the affinity information to the memory device.

9. The information handling system of claim 1, further comprising:
an accelerator configured to provide second affinity information associated with accelerator;
wherein the scheduler is further configured to schedule threads on the accelerator based on the second affinity information;
wherein the information handling system is configured to provide a second indication to the scheduler to schedule a second thread on the accelerator; and
wherein the scheduler is further configured to determine that the second thread is to be scheduled on the processor based on the first and second affinity information, and to schedule the second thread on the accelerator based on the second indication.

10. The information handling system of claim 1, wherein in providing the first affinity information, the processor is configured to implement an Intel Enhanced Hardware Guided Scheduling.

11. A method, comprising:
providing, on an information handling system, a processor having first cores of a first type and second cores of a second type, the processor configured to provide first affinity information associated with the first cores and the second cores; and
providing, on the information handling system, a scheduler configured to schedule threads on the first cores and the second cores based on the first affinity information;
providing a first indication to the scheduler to schedule a first thread on the first cores;
determining, by the scheduler, that first thread is to be scheduled on the second cores based on the first affinity information; and
scheduling, by the scheduler, the first thread on the first cores based on the first indication.

12. The method of claim 11, wherein the first cores include performance cores and the second cores include efficiency cores.

13. The method of claim 12, further comprising determining that the first thread is to be scheduled on the second cores when the information handling system is in an efficiency mode of operation.

14. The method of claim 13, wherein providing the first indication is in response to a user input to the information handling system, the user input selecting the first thread.

15. The method of claim 12, further comprising:
providing a second indication to the scheduler to schedule a second thread on the second cores;
determining that second thread is to be scheduled on the first cores based on the first affinity information; and
scheduling the second thread on the second cores based on the second indication.

16. The method of claim 15, further comprising determining that the second thread is to be scheduled on the first cores when the information handling system is in a performance mode of operation.

17. The method of claim 16, wherein providing the second indication is in response to a user input to the information handling system, the user input selecting the second thread.

18. The method of claim 11, further comprising providing a memory device, wherein the processor is further configured to store the affinity information to the memory device.

19. The method of claim 11, further comprising:
providing, on the information handling system, an accelerator configured to provide second affinity information associated with accelerator, wherein the scheduler is further configured to schedule threads on the accelerator based on the second affinity information;
providing a second indication to the scheduler to schedule a second thread on the accelerator;
determining, by the scheduler, that the second thread is to be scheduled on the processor based on the first and second affinity information; and
scheduling, by the scheduler, the second thread on the accelerator based on the second indication.

20. An information handling system, comprising:
a processor having a plurality of performance cores and a plurality of efficiency cores, the processor configured to provide affinity information associated with the performance cores and the efficiency cores based on an Intel Enhanced Hardware Guided Scheduling; and
a scheduler configured to schedule threads on the performance cores and the efficiency cores based on the affinity information;
wherein the information handling system is configured to provide an indication to the scheduler to schedule a thread on the performance cores; and
wherein the scheduler is further configured to determine that the thread is to be scheduled on the efficiency cores based on the affinity information, and to schedule the thread on the performance cores based on the indication.
